(19) United States
(12) Patent Application Publication
(10) Pub. No.: US 2024/0411099 A1
(43) Pub. Date: Dec. 12, 2024

(54) Fiber Optic Cable Protector

(71) Applicant: EAS IP, LLC, Arvonia, VA (US)

(72) Inventors: Ryan C. Dunn, Charlottesville, VA (US); Joshua M. Parman, Palmyra, VA (US)

(73) Assignee: EAS IP, LLC, Arvonia, VA (US)

(21) Appl. No.: 18/636,230

(22) Filed: Apr. 15, 2024

Related U.S. Application Data
(60) Provisional application No. 63/459,611, filed on Apr. 15, 2023.

(51) Int. Cl. G02B 6/44

(52) U.S. Cl. CPC G02B 6/4469

(57) ABSTRACT

An elongated, marked protective sheath is disclosed which is closed along each side and open at each end and which has an elongated and flexible core material contained within the entire length of the elongated, marked protective sheath and extending from each open end. The elongated, marked protective sheath may be imprinted with anti-theft indicia indicating that elongated, marked protective sheath contains only fiber optic cable and does not contain copper. The core material extending from one end of the sheath may be tied to the front end of a fiber optic cable and then pulled into the sheath—thus pulling the fiber optic cable into the sheath. In this manner, the fiber optic cable will be almost completely contained within the elongated sheath which has the aforementioned markings thereon to alert individuals that the sheath only contains fiber optic cable and does not contain copper.

### GOVERNMENT SUPPORT

Not Applicable

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### BACKGROUND OF THE INVENTION

This invention is directed in general to the protection of elongated wire or cable-like elements which are designed to be buried underground but which are may be temporarily laid out above ground prior to burial. Specifically, it is directed to theft protection for fiber optic cables which have been laid out on the ground surface and temporarily left there before burial.

In the building industry it is not uncommon for fiber optic cable contractor to lay out fiber optic cable runs and temporarily leave them on the soil surface before burying the cable. Sometimes, theft occurs before the fiber optic cable can be buried—often because the thieves think the cable contains copper.

The inventors have developed an anti-theft device which can be used in this situation. The device comprises a sheath into which the laid-out fiber optic cable can be easily inserted. The sheath is clearly marked to indicate that the cable therein is fiber optic cable and does not contain copper.

### BRIEF SUMMARY OF THE INVENTION

This invention comprises an elongated sheath which is closed along each side and open at each end and which has an elongated and flexible core material contained within the entire length of the elongated sheath and extending from each open end of the sheath. The elongated sheath may also be imprinted with anti-theft indicia to indicate that the elongated sheath contains only fiber optic cable and does not contain copper. The core material extending from one end of the sheath may be tied to the front end of a fiber optic cable and then pulled into the sheath—thus pulling the fiber optic cable into the sheath. In this manner, the fiber optic cable will be almost completely contained within the elongated sheath which has the aforementioned markings thereon to alert individuals that the sheath only contains fiber optic cable and does not contain copper. At a later time, when the contractor is ready to bury the fiber optic cable, the sheath assembly with the fiber optic cable inside can be buried thus giving extra protection for the fiber optic cable from the elements and damage which may be caused by contact with the ground [moisture, mechanical abrasion, chemical action, etc., etc.].

### BRIEF DESCRIPTION OF THE DRAWINGS

FIG. 1 shows a plan view of the elongated, marked sheath of the invention.

FIG. 2 shows a cross-sectional view of the elongated, marked sheath of FIG. 1 taken along section line A-A.

FIG. 3 shows a second embodiment of the elongated, marked sheath of the invention.

FIG. 4 shows a first generic strip and components of this strip.

FIG. 5 illustrates elements of the top surface of a second generic strip.

FIG. 6 shows a partial side view of the strip of FIG. 5 taken along the direction of Arrow E in FIG. 5.

FIG. 7 illustrates the bottom surface of the strip of FIG. 5 taken along the direction of Arrow F in FIG. 5.

FIG. 8 shows a first modification of the embodiment of the invention as shown in FIG. 2.

FIG. 9 illustrates a second modification of the embodiment of the invention shown in FIG. 2.

FIG. 10 shows a fourth modification of the embodiment of the invention shown in FIG. 2.

FIG. 11 illustrates a modification of the second embodiment of the invention shown in FIG. 3.

### DETAILED DESCRIPTION OF THE INVENTION

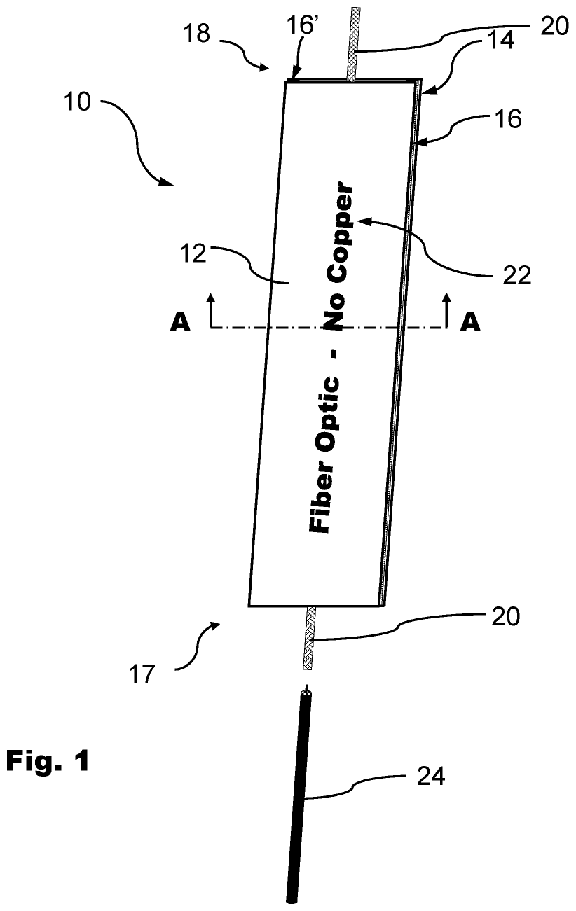

FIG. 1 shows a plan view of the elongated, marked sheath 10 of the invention. Elongated, marked sheath 10 comprises an upper protective material layer 12 comprising a first strip with a first length and a first width which is superposed with and joined to lower protective material layer 14 which comprises a second strip which second strip has a second length and a second width. The outside surface of the first strip comprising upper protective material layer 12 may have anti-theft indicia 22 applied thereon which indicia will indicate that elongated, marked sheath 10 contains only fiber optic cable and contains no copper. Anti-theft indicia 22 may also be placed on the outside surface [the lower surface] of the second strip comprising lower protective material 14. Of course, it is possible to place anti-theft indicia 22 on both the first strip comprising upper protective material layer 12 and the second strip comprising lower protective material 14. It is also noted that anti-theft indicia 22 may be reverse imprinted on the lower surface of the first strip comprising upper protective material layer 12 if this first strip is transparent or at least partially transparent. Anti-theft indicia could also be reverse imprinted on the upper surface of the second strip comprising lower protective material 14 if this strip is transparent or at least partially transparent.

The first length of the strip comprising upper protective material layer 12 is substantially equal to the second length of the strip comprising lower protective material 14. The first width of the strip comprising upper protective material layer 12 is substantially equal to the second width of the strip comprising lower protective material layer 14. What applicants mean by the lengths being “substantially equal” is that the length of the strip comprising upper protective material layer 12 is equal to the length of the strip comprising lower protective material layer 14 within a few inches [0 to 5 inches or 0 to 12.7 cm]. What applicants mean by the widths being “substantially equal” is that the width of the strip comprising upper protective material layer 12 is equal to the width of the strip comprising lower protective material layer 14 to within approximately 0-0.5 inches or 0-1.27 cm. Upper protective material layer 12 and lower protective material layer 14 are joined by adhesive 16, 16′. Adhesive 16, 16′ is applied to the lower surface of upper protective material layer 12 and the upper surface of lower protective material layer 14 along the lateral edge portions thereof [note the general discussion of strip elements below.] Adhesive 16, 16′ is confined to the outer edge portions of the lower surface of upper protective material layer 12 and the outer edge portions of the upper surface of lower protective material layer 14 which outer edge portions run along the side edges of protective material layers 12, 14. [Note the general discussion of strip elements below]. An elongated, marked sheath 10 is thus formed with closed sides and an open proximal end 17 and an open distal end 18. Elongated core material 20 is placed in the central area of elongated, marked sheath 10 and is thus free from any adhesive so that elongated core material 20 may freely move inside elongated, marked sheath 10.

It is noted that elongated core material 20 extends slightly from both proximal open end 17 and distal open end 18 of elongated, marked sheath 10. That is, the length of elongated core material 20 is slightly longer than the length of the strip comprising upper protective material 12 and slightly longer than the length of the strip comprising lower protective material layer 14. What applicants mean by “slightly longer” in this context is that there will be enough of the core material extending from the open ends on each side to permit the core material to be conveniently handled such as to pull on it or to tie the core material to a fiber optic cable. Thus the core material would need to extend about 6 to 12 inches [15.24-30.48 cm] from each open end of elongated, marked sheath 10. A portion of a fiber optic cable 24 is shown aligned with the end of elongated core material 20 extending from proximal end 17 of elongated, marked sheath 10.

It is noted that elongated, marked sheath 10 will be much longer than it is wide. Fiber optic cable runs may well be a thousand feet long [or longer]—so elongated, marked sheet 10 would also have to be of a similar length. It is possible that for ease of installation of the fiber optic cable inside elongated, marked sheath 10, it may be desirable to break up a long run of fiber optic cable into several shorter runs which can be joined together in order to provide for shorter lengths of elongated, marked sheath 10—say lengths of several hundred feet or so such that it will be easier to pull the fiber optic cable into elongated, marked sheath 10.

If a fiber optic cable contractor finds it necessary or convenient to lay out the fiber optic cable on the surface of the soil and temporarily leave it there before burial, proximal end 17 of elongated, marked sheath 10 may be aligned with an end of the fiber optic cable as shown in FIG. 1. The portion of elongated core material 20 extending from proximal end 17 may be tied to the end of fiber optic cable 24 and the fiber optic cable 24 may then be pulled inside elongated, marked sheath 10 by pulling on the end of elongated core material 20 which extends from distal end 18 of elongated, marked sheath 10. Once fiber optic cable 24 has been pulled into elongated, marked sheath 10, it is protected against potential theft by elongated, marked sheath 10 which warns anyone that elongated, marked sheath 10 only contains fiber optic cable and does not have any copper therein. When the fiber optic cable contractor is ready to bury the cable, the assembled elongated, marked sheath 10 with fiber optic cable 24 contained inside may be buried thus providing additional protection to fiber optic cable 24 from damage which may be caused by contact with the ground [moisture, mechanical abrasion, chemical action, etc., etc.]. It is noted that fiber optic cable 24 would normally extend slightly [about 6 to 12 inches {15.24-30.48 cm}] from each open end of elongated, marked sheath 10 after it was pulled into and through sheath 10 as described above.

Protective material layers 12, 14 may be made from any suitable material. It is envisioned that suitable materials might be thin layers of synthetic plastics, for example, polyethylene, polypropylene, polyvinylidene chloride [e.g. Saran™] or a fluorocarbon. A typical thickness for material layers 12, 14 might be 0.001-0.002 inches [0.00254-0.00508 cm] although other thicknesses may be used, as desired and/or necessary.

Any suitable adhesive 16, 16′ may be used to join protective material layers 12 and 14 together. It is noted that applicants consider that the process of joining protective material layers 12 and 14 using adhesive may be referred to as laminating protective material layers 12, 14 together. It is noted that one of the definitions of the verb “laminate” in the Merriam Webster® Online Dictionary is “to unite (layers of material) by adhesive or other means”. Applicants also consider that processes other than adhesive bonding may also be referred to as “laminating”. For example, it is possible to “laminate” layers 12, 14 together using adhesive, heat sealing, ultrasonic welding, or any other suitable joining process. Any process of joining protective material layers 12, and 14 together is acceptable if it will properly seal elongated, marked sheath 10 against damage which may be caused by contact with the ground, ground water or chemicals in the ground.

It would also be possible to make elongated, marked sheath 10 by folding in half a layer approximately twice as wide as the desired width of finished elongated, marked sheath 10. The fold would be made about the longitudinal center line of the layer. The opposing ends of the folded layer would then be laminated together with adhesive, heat sealing, ultrasonic welding or any other suitable joining process. This technique is described in commonly owned published International Application WO 2022 191849 and illustrated in FIGS. 34-38 of the above-noted published International Application.

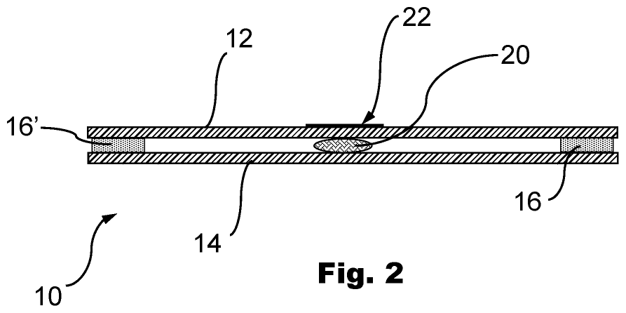

FIG. 2 illustrates a cross-section of elongated, marked sheath 10 taken along section line A-A of FIG. 1. Upper protective material layer 12 is joined to lower protective material layer 14 by adhesive 16, 16′ which is only located on the outer edge portions of the strips comprising protective material layers 12, 14. Elongated core material 20 is placed generally in the middle of the assembled elongated, marked sheath 10. It is noted that elongated, core material 20 is shown with an oval cross-section in FIG. 2; however, it is obvious that the cross-section of elongated core material 20 may be other than oval, for example, it might be circular, square or rectangular or any other suitable geometric shape. Anti-theft indicia 22 is imprinted upon the upper surface of the strip comprising upper protective material layer 12. It is noted that elongated core material 20 may be made from any suitable material but it is envisioned that elongated core material 20 will probably be made from a polyester or aramid fiber fabric tape such as the fabric core materials disclosed in commonly owned U.S. patent application Ser. No. 16/331,525, filed as PCT/US2017/050405 on 7 Sep. 2017.

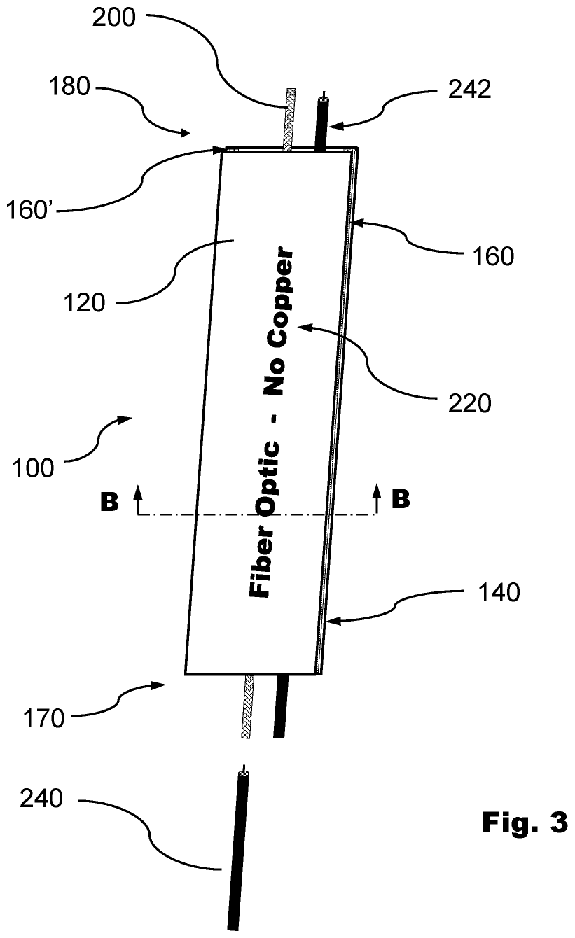

FIG. 3 illustrates a second embodiment of the invention. Elongated, marked sheath 100 is shown comprising upper protective material layer 120 which is shown as being joined to lower protective material layer 140 by adhesive 160, 160′. Elongated, marked sheath 100 has an open proximal end 170 and an open distal end 180. Elongated core material 200 is shown as being threaded through elongated, marked sheath 100 and as slightly extending from open proximal end 170 and open distal end 180. In addition, this embodiment has an elongated section of fiber optic cable 242 already installed inside elongated, marked sheath 100. Elongated fiber optic cable 242 also slightly extends from open proximal end 170 and open distal end 180 of elongated, marked sheath 100. It is noted that another fiber optic cable 240 may be pulled through the open proximal end 170 of elongated, marked sheath 100. Use of this second embodiment permits multiple fiber optic cables to be enclosed within elongated, marked sheath 100.

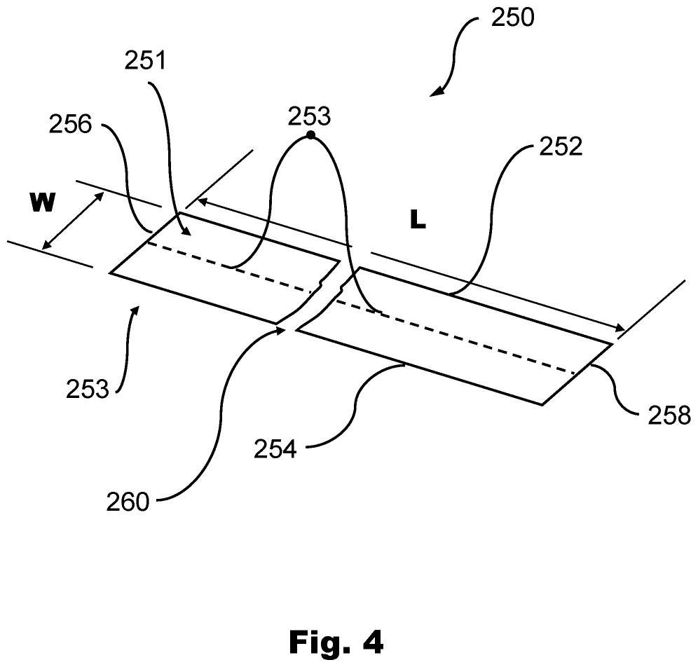

Applicants are using strip-like materials to make various components of applicants' anti-theft device. In addition, a number of the physical elements of strip-like materials are being claimed. It is therefore considered desirable to indicate exactly what applicants mean by the use of these elements. FIG. 4 illustrates a first generic strip 250 with a length L, width W, a first side edge 252, a second side edge 254, a leading edge 256 and a trailing edge 258. First and second side edges 252, 254 are generally parallel to each other and form straight lines. It is also noted that first generic strip 250—since it has parallel side edges 252, 254 also has an imaginary centerline 253 which is not actually a visible physical feature in this drawing [as side edges 252, 254 are visible features] and therefore imaginary centerline 253 is illustrated herein as a dotted line. First generic strip 250 also has an upper surface 251 and a lower surface 253. It is noted that lower surface 253 is not visible in FIG. 4 even though the numeral 253 and a lead arrow are shown in the figure. 6 Leading edge 256 and trailing edge 258 may form straight lines and may be parallel to each other or they may not be parallel and may not form straight lines. For convenience in illustrating the invention, strip 250 has been generally shown herein as a parallelogram; however, as long as side edges 252, 254 are generally parallel, there is no necessity for leading edge 256 and trailing edge 258 to be straight lines. There is also no necessity that they be parallel to each other. For example, leading edge 256 and trailing edge 258 could basically have any desired shape—semicircular, oval, jagged or any other shape. It is also to be noted that applicants are using strips which are much longer than they are wide. For example, when manufactured as applicants' anti-theft elongated, marked sheath, atypical value for length L for strip 250 would be between 200 and 1000 feet [or approximately 61 m-305 m], while a typical value for width W might be between approximately 4 inches and 12 inches [or approximately 10.2 cm-30.5 cm]. This is one reason why the interruption 260 is shown in FIG. 4 to indicate that the strip is quite long. When applicants state that the length of a strip is much longer than the width of the strip is wide, they mean that the length is intended to be many, many times longer than the strip is wide. As noted, supra, when manufactured, the elongated, marked sheath may be hundreds of feet long while the width of the strip will normally be less than one foot. This is what applicants mean when they say that the length of the strip is much longer than the strip is wide.

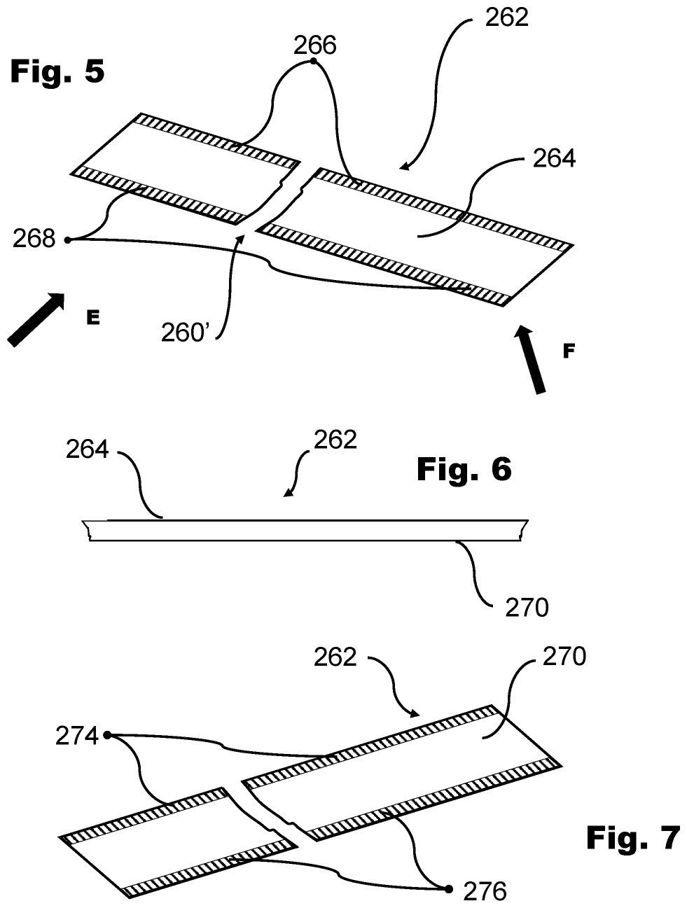

FIG. 5 shows a second generic strip 262 similar to first generic strip 250 with interruption 260′ to indicate that strip 262 is much longer than it is wide although it should be noted an interruption such as those shown by 260, 260′ has not always been included in applicants' drawings of strips and the inventive elongated, marked sheath. Second generic strip 262 is shown with a top surface 264 and first side edge portion 266 at one side of top surface 264 and a second side edge portion 268 at the other side of top surface 264. Side edge portions 266, 268 are indicated by shading and will extend somewhat inside the side edges of second generic strip 262 as shown in FIG. 5. FIG. 6 illustrates a partial side view of second generic strip 262 taken along arrow E of FIG. 5. Second generic strip 262 is shown with top surface 264 and bottom surface 270 both being visible in this figure. FIG. 7 is a bottom view of second generic strip 262 taken along arrow F of FIG. 5 and shows bottom surface 270 and first side edge portion 276 at one side edge of bottom surface 270 of second generic strip 262 and second side edge portion 274 at the other side edge of bottom surface 270. As discussed above for FIG. 5, side edge portions 274, 276 are shown by shading in FIG. 7 and extend somewhat inside the side edges of second generic strip 262.

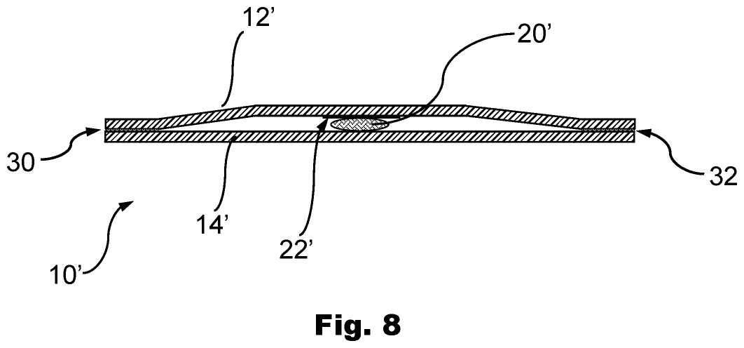

FIG. 8 shows a first modification of the embodiment of the invention shown in FIG. 2. Elongated, marked sheath 10′ is shown with upper protective material layer 12′ joined to lower protective material layer 14′ by having the side edge portions on the lower surface of the strip comprising upper protective material layer 12′ heat sealed to side portions on the upper surface of the strip comprising lower protective material layer 14′ as shown at 30, 32. It is noted that anti-theft indicia 22′ is reverse imprinted on the lower surface of the strip comprising upper protective material layer 12′ instead of being imprinted on the upper surface of the strip comprising upper protective material layer 12 as shown in FIG. 2. It is further noted that, in this embodiment, at least the portion of upper protective material layer 12′ immediately above anti-theft indicia 22′ would have to be transparent in order for anti-theft indicia 22′ to be visible from outside the elongated, marked sheath 10′. Elongated core material 20′ is slidably contained within upper protective material layer 12′ and lower protective material layer 14′.

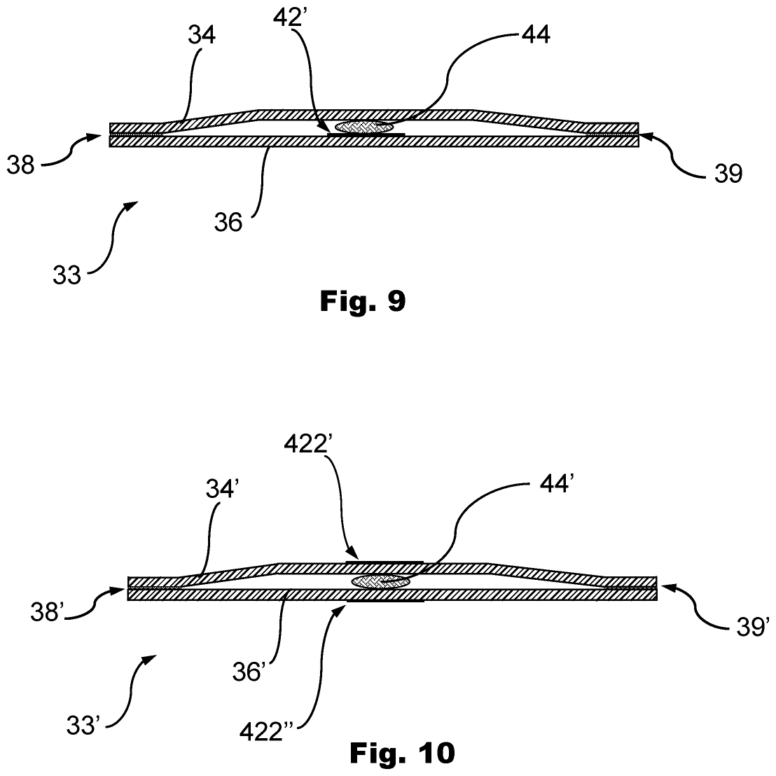

FIG. 9 illustrates a second modification of the embodiment of the invention shown in FIG. 2. Elongated, marked sheath 33 comprises upper protective material layer 34 joined to lower protective material layer 36 by having the side edge portions on the lower surface of the strip comprising upper protective material layer 34 ultrasonically welded to corresponding side portions on the upper surface of the strip comprising lower protective material layer 36 as shown at 38, 39. Anti-theft indicia 42′ is reverse imprinted to the upper surface of the strip comprising lower protective material layer 36. It is further noted that, in this embodiment, at least the portion of lower protective material layer 36 immediately above anti-theft indicia 42′ would have to be transparent in order for anti-theft indicia 42′ to be visible from outside the elongated, marked sheath 33. In addition, elongated core material 44 is slidably contained within upper protective material layer 34 and lower protective material layer 36.

FIG. 10 illustrates a second modification which is similar to but not identical to the embodiment of the invention shown in FIG. 2. Elongated, marked sheath 33′ comprises upper protective material layer 34′ joined to lower protective material layer 36′ by having the side edge portions on the lower surface of the strip comprising upper protective material layer 34′ ultrasonically welded to corresponding side portions on the upper surface of the strip comprising lower protective material layer 36′ as shown at 38′, 39′. Anti-theft indicia 422′ is imprinted on the upper surface of the strip comprising upper protective material layer 34′ and additional anti-theft indicia 422″ is imprinted on the lower surface of the strip comprising lower protective material layer 36′. In addition, elongated core material 44′ is slidably contained within upper protective material layer 34′ and lower protective material layer 36′.

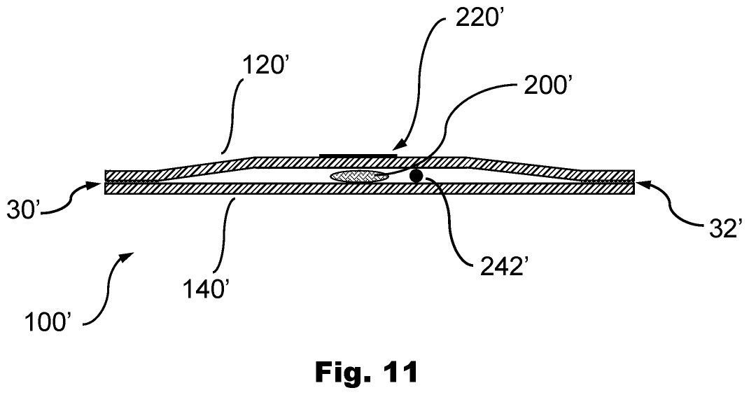

FIG. 11 shows a modification which is similar to but not identical to the embodiment of the invention shown in FIG. 3. A cross-section of this modification is shown herein which is similar to a cross-section of the elongated, marked protective sheath 100 of FIG. 3 is shown taken along section line B-B. Note that in FIG. 11, elongated core material 200′ is not shown as similar in lateral dimension to fiber optic cable 242′ and that while fiber optic cable 242 and elongated core material 200 are shown in FIG. 3 as being of generally circular cross-section, elongated core material 200′ is shown in FIG. 11 as being oval in cross-section. Elongated, marked protective sheath 100′ comprises upper protective material layer 120′ joined to lower protective material layer 140′ by having the side portions on the lower surface of the strip comprising upper protective material layer 120′ heat sealed to corresponding side portions on the upper surface on the strip comprising lower protective material layer 140′ as shown at 30′, 32′. In addition, elongated core material 200′ is slidably contained within upper protective material layer 120′ and lower protective material layer 140′. Anti-theft indicia 220′ is imprinted on the upper surface of the strip comprising upper protective material layer 120′. Elongated core material 200′ is slidably contained within upper protective material layer 120′ and lower protective material layer 140′. In this embodiment a length of fiber optic cable 242′ is also positioned between upper protective material layer 120′ and lower protective material layer 140′ to one side of elongated core material 200′ such that it is possible to pull another length of fiber optic cable [not shown in FIG. 11] into elongated, protective sheath 100′ using elongated core material 200′ in a similar manner to that described above.

1. An elongated protective sheath comprising protective material and elongated core material:
said protective material further comprising;
an upper protective material layer comprising a first strip having
a first length,
a first top surface and a first bottom surface,
a side edge portion along each side of said first strip on both said first top surface and said first bottom surface; and,
a first width,
with said first length being much longer than said first width is wide;
a lower protective material layer comprising a second strip having
a second length,
a second top surface and a second bottom surface,
a side edge portion along each side of said second strip on both said second top surface and said second bottom surface; and,
a second width,
with said second length being much longer than said second width is wide;
with said first and said second lengths being substantially equal and said first and said second widths being substantially equal;
said upper protective material layer and said lower protective material layer being superposed and secured together at said side edge portions of said first bottom surface and said side edge portions of said second top surface to form said elongated protective sheath, with said elongated protective sheath having closed side edges and an open end at each end of said elongated protective sheath;
an elongated core material positioned between the first bottom surface and said second top surface such that said elongated core material may freely slide along the length of said first and said second strips, with said elongated core material having a third length with said third length being slightly longer than said first length.

2. The elongated protective sheath of claim 1 wherein anti-theft indicia is imprinted on said first top surface.

3. The elongated protective sheath of claim 2 wherein said anti-theft indicia indicates that the elongated protective sheath contains fiber optic cable and does not contain copper.

4. The elongated protective sheath of claim 1 wherein said upper protective material layer and said lower protective material layer are secured together by adhesive layers along said side edge portions of said first bottom surface and on said side edge portions of said second top surface.

5. The elongated protective sheath of claim 1 wherein said upper protective material layer and said lower protective material layer comprise thermoplastic materials and are secured together by heat sealing said side edge portions of said first bottom surface and said side edge portions of said second top surface together.

6. The elongated protective sheath of claim 1 wherein said upper protective material layer and said lower protective material layer comprise thermoplastic materials and are secured together by ultrasonic welding said side edge portions of said first bottom surface and said side edge portions of said second top surface together.

7. The elongated protective sheath of claim 1 wherein at least a portion of said first strip is transparent and wherein anti-theft indicia is reverse imprinted on said first bottom surface below said transparent portion.

8. The elongated protective sheath of claim 7 wherein said anti-theft indicia indicates that the elongated protective sheath contains fiber otic cable and does not contain copper.

9. The elongated protective sheath of claim 1 wherein at least a portion of said second strip is transparent and wherein anti-theft indicia is reverse imprinted on said first bottom surface above said transparent portion, said indicia indicating that the elongated, protective sheath contains fiber optic cable and does not contain copper.

10. The elongated protective sheath of claim 1 wherein anti-theft indicia is imprinted on said first top surface and said second bottom surface, said indicia indicating that the elongated, protective sheath contains fiber optic cable and does not contain copper.

11. An elongated protective sheath comprising protective material and an elongated core material:
said protective material further comprising;
an upper protective material layer comprising a first strip having a first length,
a first top surface and a first bottom surface,
a side edge portion along each side of said first strip on both said first top surface and said first bottom surface; and,
a first width,
with said first length being much longer than said first width is wide;
a lower protective material layer comprising a second strip having
a second length,
a second top surface and a second bottom surface,
a side edge portion along each side of said second strip on both said second top surface and said second bottom surface; and,
a second width,
with said second length being much longer than said second width is wide;
with said first and said second lengths being substantially equal and said first and said second widths being substantially equal;
said upper protective material layer and said lower protective material layer being superposed and secured together at said side edge portions of said first bottom surface and said side edge portions of said second top surface to form said elongated protective sheath, with said elongated protective sheath having closed side edges and an open end at each end of said elongated protective sheath;
an elongated core material positioned between said first bottom surface and said second top surface such that said elongated core material may freely slide along the length of said first and said second strips, with said elongated core material having a third length with said third length being slightly longer than said first length;
a length of fiber optic cable positioned between said first bottom surface and said second top surface to one side of said elongated core material, with said fiber optic cable having a fourth length, with said fourth length being slightly longer than said first length.

12. The elongated protective sheath of claim 11 wherein anti-theft indicia is imprinted on said first top surface.

13. The elongated protective sheath of claim 12 wherein said anti-theft indicia indicates that the elongated protective sheath contains fiber optic cable and does not contain copper.

14. The elongated protective sheath of claim 11 wherein said upper protective material layer and said lower protective material layer comprise thermoplastic materials and are laminated together along said side edge portions of said first bottom surface and on said side edge portions of said second top surface.

15. The elongated protective sheath of claim 11 wherein said upper protective material layer and said lower protective material layer comprise thermoplastic materials and are laminated together by heat sealing said side edge portions of said first bottom surface and said side edge portions of said second top surface together.

16. A method of protecting fiber optic cable from theft comprising the steps of:
laying out a first length of fiber optic cable in a desired configuration on the surface of the ground;
providing an elongated, marked protective sheath for said fiber optic cable, said elongated, marked protective sheath further comprising
an upper protective material layer comprising a first strip having
a second length,
a first top surface and a first bottom surface,
a side edge portion along each side of said first strip on both said first top surface and said first bottom surface; and,
a first width,
with said second length being much longer than said first width is wide;
a lower protective material layer comprising a second strip having
a third length,
a second top surface and a second bottom surface,
a side edge portion along each side of said second strip on both said second top surface and said second bottom surface; and,
a second width,
with said third length being much longer than said second width is wide;
with said second and said third lengths being substantially equal and said first and said second widths being substantially equal;
said upper protective material layer and said lower protective material layer being superposed and secured together at said side edge portions of said first bottom surface and said side edge portions of said second top surface to form said elongated protective sheath, with said elongated protective sheath having closed side edges and an open end at each end of said elongated protective sheath;
an elongated core material positioned between the first bottom surface and said second top surface such that said elongated core material may freely slide along the length of said first and said second strips, with said elongated core material having a fourth length with said fourth length being slightly longer than said second length, such that a portion of said elongated core material extends from each said open ends of said elongated, marked protective sheath,
with said elongated, marked protective sheath further comprising anti-theft indicia imprinted on at least one of said first top surface and said second bottom surface with said anti-theft indicia indicating that the elongated, marked protective sheath contains fiber optic cable and does not contain copper;
positioning said elongated protective sheath on the ground near one end of said first length of fiber optic cable with the end of said elongated core material extending from the open end of said elongated protective sheath closest to said fiber optic cable being positioned near said one end of said first length of fiber optic cable;
tying said end of said elongated core material to said one end of said first length of fiber optic cable;
pulling on the end of said elongated core material extending from said other open end of said elongated, marked protective sheath thus pulling said fiber optic cable into said protective, marked sheath.

17. A method of protecting fiber optic cable from theft comprising the steps of:
laying out a first length of fiber optic cable in a desired configuration on the surface of the ground;
providing an elongated, marked protective sheath for said fiber optic cable, said elongated, marked protective sheath further comprising
an upper protective material layer, comprising a first strip having
a second length,
a first top surface and a first bottom surface; and,
a first width,
a lower protective material layer, comprising a second strip having
a third length,
a second top surface and a second bottom surface; and,
a second width,
with said second and said third lengths and said first and said second widths being substantially equal;
said upper protective material layer and said lower protective material layer being superposed and secured together at the side edge portions of said first bottom surface and said side edge portions of said second top surface to form said elongated protective sheath, with said elongated protective sheath having closed side edges and an open end at each end of said elongated protective sheath;
an elongated core material positioned between the first bottom surface and said second top surface such that said elongated core material may freely slide along the length of said first and said second strips, with said elongated core material having a fourth length with said fourth length being slightly longer than said second length, such that a portion of said elongated core material extends from each said open ends of said elongated, marked protective sheath,
with said elongated, marked protective sheath further comprising anti-theft indicia imprinted on at least one of said first top surface and said second bottom surface with said anti-theft indicia indicating that the elongated, marked protective sheath contains fiber optic cable and does not contain copper;
positioning said elongated protective sheath on the ground near one end of said first length of fiber optic cable with the end of said elongated core material extending from the open end of said elongated protective sheath closest to said fiber optic cable being positioned near said one end of said first length of fiber optic cable;
tying said end of said elongated core material extending from the open of said elongated protective sheath closest to said fiber optic cable to said one end of said length of fiber optic cable;
pulling on the other end of said elongated core material extending from said other open end of said elongated, marked protective sheath thus pulling said fiber optic cable into said protective, marked sheath.
